(19) United States
(12) Patent Application Publication
(10) Pub. No.: US 2016/0005072 A1
(43) Pub. Date: Jan. 7, 2016

(54) METHOD AND SYSTEM FOR ONLINE COMMERCE ANALYSIS

(71) Applicant: MasterCard International Incorporated, Purchase, NY (US)

(72) Inventor: Andrew A. ROBINSON, Bessacarr (GB)

(73) Assignee: MASTERCARD INTERNATIONAL INCORPORATED, Purchase, NY (US)

(21) Appl. No.: 14/321,192

(22) Filed: Jul. 1, 2014

(51) Int. Cl. G06Q 30/02

(52) U.S. Cl. CPC G06Q 30/0255; G06Q 30/0201

(57) ABSTRACT

A system for analyzing spending data includes a receiving device and a processing device. The receiving device is configured to receive transaction data for a plurality of payment transactions for a plurality of consumers, wherein the transaction data for each of the plurality of payment transactions includes at least purchase data and a payment transaction type. The processing device is configured to: categorize the transaction data from the storage device based on the payment transaction type; generate a filtered list of transaction data including transaction data for payment transactions conducted online; and analyze, for each of the payment transactions included in the filtered list of transactions, spending behaviors based on the associated transaction data, wherein analyzing spending behaviors includes categorizing the plurality of consumers based on frequency of payment transactions conducted online.

### FIELD

The present disclosure relates to technology facilitating the analysis of spending data, specifically categorizing a plurality of consumers based on the spending conducted online.

### BACKGROUND

With the increase in online spending by consumers, merchants, retailers, offer providers, and other entities have an increased desire to advertise, distribute offers, or otherwise push content to the consumers based on the consumer's particular spending behavior. The many merchants, retailers, offer providers, and other entities tend to have limited information about the consumers. Some methods for distributing content to the consumers include distributing offers or advertisements to all consumers that have made a purchase from the merchant and have provided contact information. However, such methods rely on the purchase history of the individual consumer with a single merchant, without regard for the preferences of the consumer or additional purchases from different merchants, which may result in a low success rate and be difficult to apply to other merchants.

Consumers may also be less likely to sort through the offers or advertisements to find the ones relevant to their particular interest when they receive multiple offers or advertisements from merchants where they may have only conducted a single transaction.

However, obtaining additional meaningful insights into the spending behavior of users is technologically challenging, particularly on a commercial scale, and more particularly within a given segment of the market such as online spending. This presents a technical problem of how to gather and analyze the information.

Therefore, there is a need to develop technical solutions for gaining additional insights into the spending behavior of the consumers when transactions are conducted online and/or use this insight to target advertisements and offers to generate increased sales.

### SUMMARY

The present disclosure provides a description of a system and method for analysis of online spending behavior that provides a technical solution not found in the prior art.

A method for analyzing spending data, includes: receiving, by a receiving device, transaction data for a plurality of payment transactions for a plurality of consumers, wherein the transaction data for each of the plurality of payment transactions includes at least purchase data and a payment transaction type; categorizing, by a processing device, the transaction data from the storage device based on the payment transaction type; generating, by the processing device, a filtered list of transaction data including transaction data for payment transactions conducted online; and analyzing, for each of the payment transactions included in the filtered list of transactions, spending behaviors based on the associated transaction data, wherein analyzing spending behaviors includes categorizing the plurality of consumers based on frequency of payment transactions conducted online.

A system for analyzing spending data includes a receiving device and a processing device. The receiving device is configured to receive transaction data for a plurality of payment transactions for a plurality of consumers, wherein the transaction data for each of the plurality of payment transactions includes at least purchase data and a payment transaction type. The processing device is configured to: categorize the transaction data from the storage device based on the payment transaction type; generate a filtered list of transaction data including transaction data for payment transactions conducted online; and analyze, for each of the payment transactions included in the filtered list of transactions, spending behaviors based on the associated transaction data, wherein analyzing spending behaviors includes categorizing the plurality of consumers based on frequency of payment transactions conducted online.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIGS. 1A, 1B, 1C are a high level architecture and data flow diagram illustrating a system for the analysis of transaction data to determine frequency of online spending in accordance with exemplary embodiments.

FIG. 2 is a block diagram illustrating the processing server of FIGS. 1A, 1B, 1C for the analysis of transaction data in accordance with exemplary embodiments.

FIG. 3 is a flow chart illustrating a method for analyzing transaction data to determine frequency of online spending in accordance with exemplary embodiments.

FIG. 4 is block diagram illustrating the transaction database of FIGS. 1A, 1B, 1C in accordance with exemplary embodiments.

FIG. 5 is a flow chart illustrating a method for analyzing transaction data to determine frequency of online spending in accordance with exemplary embodiments.

FIG. 6 is a graph illustrating the analysis results in accordance with exemplary embodiments.

FIG. 7 is a three-dimensional block illustrating the analysis results in accordance with exemplary embodiments.

FIG. 8 is a graph illustrating the analysis results in accordance with exemplary embodiments.

FIG. 9 is a block diagram illustrating computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Merchant—An entity that provides products (e.g., goods and/or services) for purchase by another entity, such as a consumer or another merchant. A merchant may be a consumer, a retailer, a wholesaler, a manufacturer, individual, or any other type of entity that may provide products for purchase as will be apparent to persons having skill in the relevant art. In some instances, a merchant may have special knowledge in the goods and/or services provided for purchase. In other instances, a merchant may not have or require and special knowledge in offered products. In some embodiments, an entity involved in a single transaction may be considered a merchant, and may be someone otherwise not in a related business, such as a purchaser in a person to person exchange.

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, etc.

Payment Account—A financial account that may be used to fund a transaction, such as a checking account, savings account, credit account, debit account, virtual payment account, etc. A payment account may be associated with an entity, which may include a person, family, company, corporation, governmental entity, etc. In some instances, a payment account may be virtual, such as those accounts operated by PayPal®, etc.

Transaction Account—A card or data associated with a payment account that may be provided to a merchant in order to fund a financial transaction via the associated payment account. Transaction accounts may include credit cards, debit cards, charge cards, stored-value cards, prepaid cards, fleet cards, virtual payment numbers, virtual card numbers, controlled payment numbers, etc. A transaction account may be a physical card that may be provided to a merchant, or may be data representing the associated payment account (e.g., as stored in a communication device, such as a smart phone or computer). For example, in some instances, data including a payment account number may be considered a transaction account for the processing of a transaction funded by the associated payment account. In some instances, a check may be considered a transaction account where applicable.

Advertising Agency—Advertising agencies, merchants, retailers, offer providers and other entities that produce and/or distribute advertisements, coupons, offers, rewards or any other mechanism that is designed to encourage a consumer to consume a product and/or service.

### System for Analyzing the Transaction Data

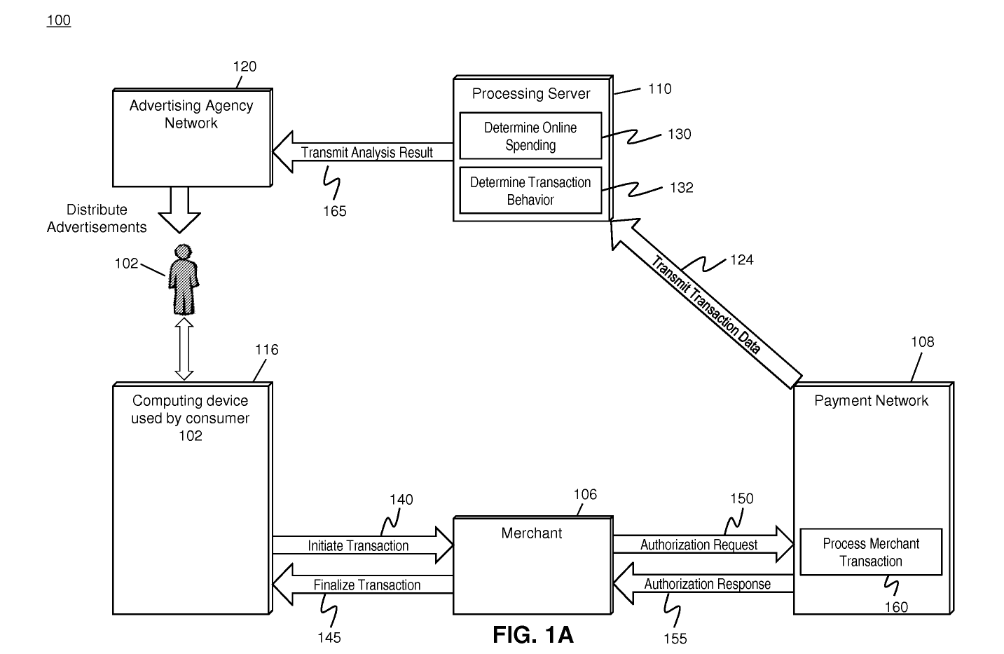

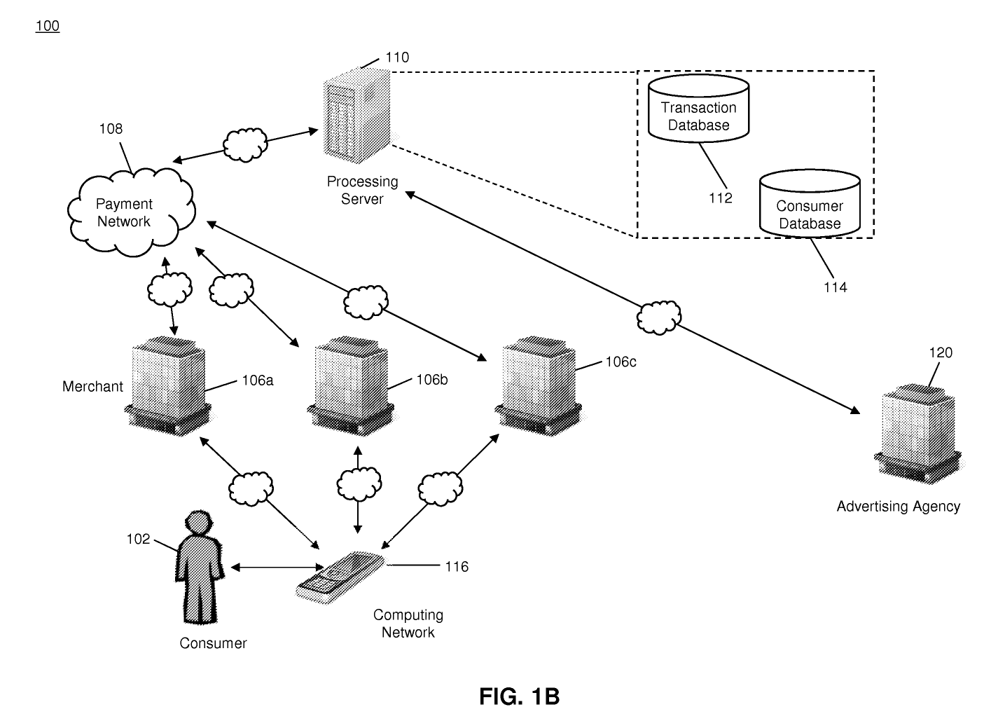

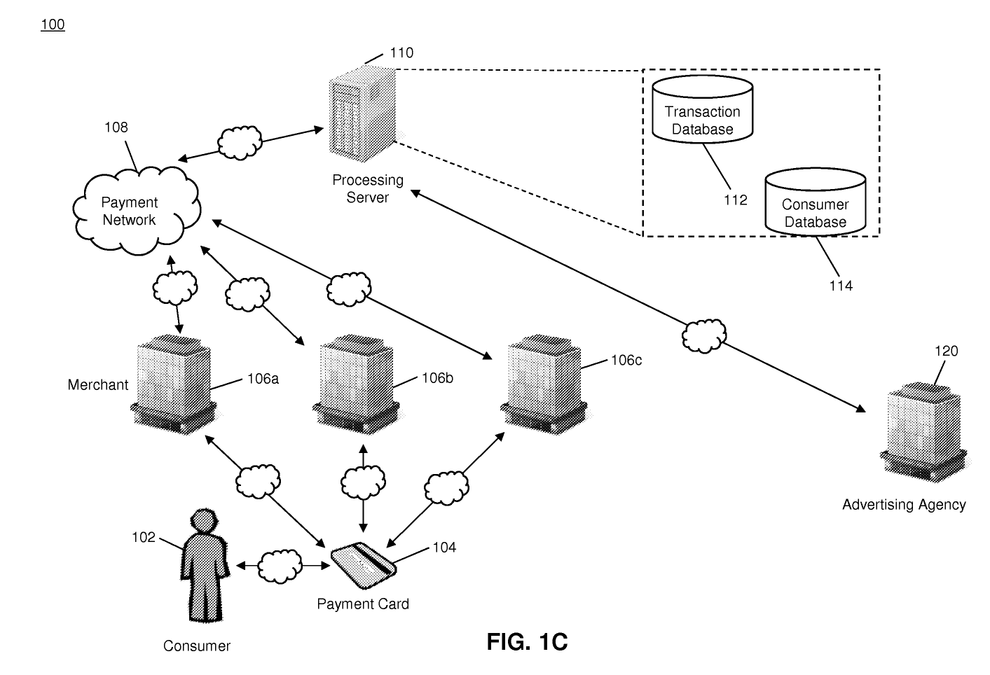

FIGS. 1A, 1B, and 1C illustrate a system 100 for the analysis of transaction data to determine frequency of online spending.

The system 100 may include a computing network 116 associated with and used by a consumer 102, such as a computing device (e.g., personal computer, tablet, laptop, PDA, smartphone etc.) connected to the internet or other network etc. In some instances, the consumer's computing device may be used at a point of sale and may be a smart phone or chip bearing credit card. Traditional swipe based cards are also included. A transaction account 104 associated with a consumer 102, such as a payment card issued to the consumer 102 by an issuer (e.g., an issuing bank) is associated with a payment account of the consumer 102 and held by the issuer. The consumer 102 may engage in financial transactions with a plurality of merchants 106, such as merchants 106a, 106b, and 106c illustrated in FIGS. 1B and 1C. As part of the financial transactions, the consumer 102 may use the payment card 104 for payment.

Each of the merchants 106 may process the financial transactions using methods that will be apparent to persons having skill in the relevant art, such as by submitting authorization requests to (e.g., via an acquirer, such as an acquiring bank) a payment network 108 for processing. The payment network 108 may process the financial transaction using methods that will be apparent to persons having skill in the relevant art. After the transaction has been completed, the payment network 108 may provide transaction data for each of the financial transactions to a processing server 110. The processing server 110, discussed in more detail below, may store the transaction data in a transaction database 112, also discussed in more detail below.

As illustrated in FIG. 1B, the system 100 may include a computing network 116 associated with and used by a consumer 102, such as a computing device (e.g., personal computer, tablet, laptop, PDA, smartphone etc.) connected to the internet or other network etc. In some instances, the consumer's computing device may be used at a point of sale and may be a smart phone or chip bearing credit card. Traditional swipe based cards are also included.

The processing server 110, discussed in more detail below, may be configured to receive transaction data for a consumer 102 and analyze the transaction data. The transaction data may correspond to a plurality of payment transactions, and may be received from a payment network 108. In some embodiments, the processing server 110 may be a part of the payment network 108 and may be further configured to perform additional functions based thereon. For example, the processing server 110 may be further configured to process payment transactions as part of the payment network 108.

The processing server 110 may include a transaction database 112, discussed in more detail below. The transaction database 112 may be configured to store transaction data associated with a plurality of payment transactions. The transaction data may include, for instance, transaction times, transaction dates, transaction amounts, merchant data, product data, consumer data, geographic locations, etc. In some embodiments, the transaction data may be captured during the processing of payment transactions by the processing server 110 and/or the payment network 108.

The system 100 may also include an advertisement agency 120. The advertisement agency 120 may be any system and/or person that would be interested in obtaining the analysis results from the processing server 110.

The processing server 110 may be configured to receive the transaction data 124 from the payment network 108 and store the transaction data 124 in the transaction database 112. The processing server 110 may then analyze the transaction data 124 to identify payment transactions that were conducted online. In some embodiments, the payment transactions analyzed may be limited to a period of time in which the advertising agency 120 is interested in.

In some embodiments, the processing server 110 may categorize the payment transactions based on transaction data. The transaction data 124 may include a plurality of purchase attributes. For example, the processing server 110 may identify consumer propensities to spend across a plurality of purchase attributes such as product categories, product names, merchant categories, merchants, industry categories, industry identifier, and/or transaction date, etc. In another example, the processing server 110 may categorize the payment transactions conducted online based on a given period of time.

In some instances, the processing server 110 may categorize the spending behavior based on a specific merchant or merchants. In such an instance, the processing server 110 may identify transactions involving a specific merchant or merchants, such as a particular merchant (e.g., Best Buy®) or a particular industry (e.g., electronics stores). The processing server 110 may then identify payment transactions conducted online directed to the particular industry.

### Processing Server

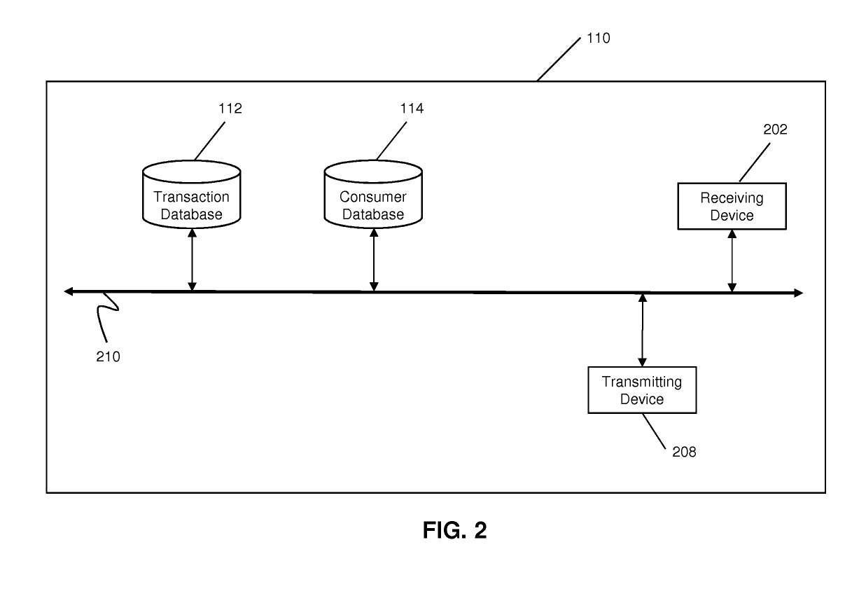

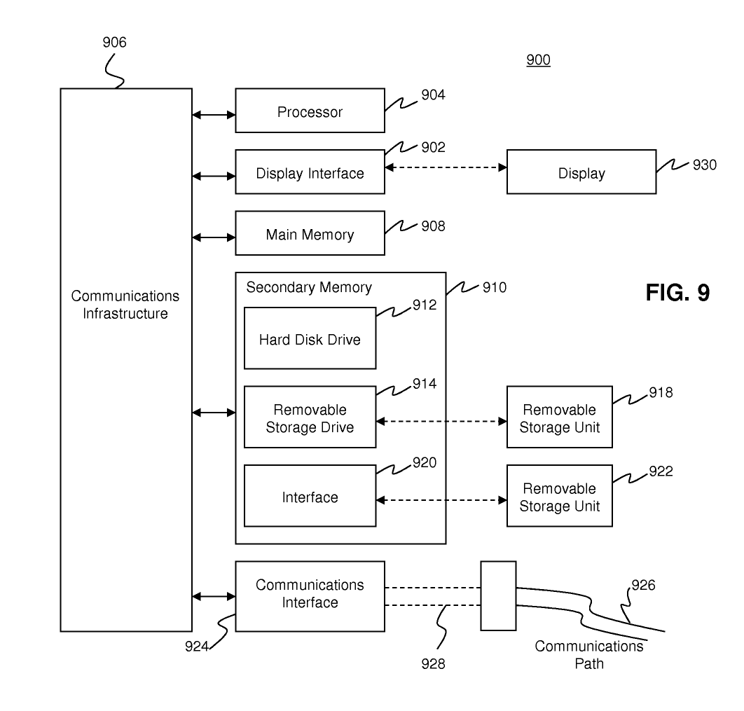

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of the processing server 110 suitable for performing the functions as discussed herein. For example, the computer system 900 illustrated in FIG. 9 and discussed in more detail below may be a suitable configuration of the processing server 110.

The processing server 110 may include a receiving device 202. The receiving device 202 may be configured to receive data from one or more networks (e.g., the Internet) via one or more network protocols (e.g., Internet Protocol), such as transaction data transmitted to the processing server 110 by the payment network 108. The processing server 110 may be configured to store the received payment transaction information in the consumer database 114 and the transaction data in the transaction database 112.

The consumer database 114 may be configured to store a plurality of payment data entries corresponding to the transaction data for the financial transactions, received from the payment network 108. Each payment data entry may include at least a consumer identifier. The consumer identifier may be a unique value associated with a consumer (e.g., the consumer 102) used for identification, and may be included in the authorization request for the corresponding financial transaction. For example, the consumer identifier may be a payment account number associated with the payment account used to fund the financial transaction. Each payment data entry may further include a location identifier, timing information, and transaction data, discussed in more detail below.

As discussed in more detail below, the processing server 110 may be configured to analyze the transaction data 124 stored in the transaction database 112 and generate a filtered set of payment transactions. The filtered set of payment transactions for each consumer are also stored in the transaction database 112. The processing server 110 may be further configured to analyze the filtered set of payment transactions and categorize the consumers based on the frequency of payment transactions conducted online as described below.

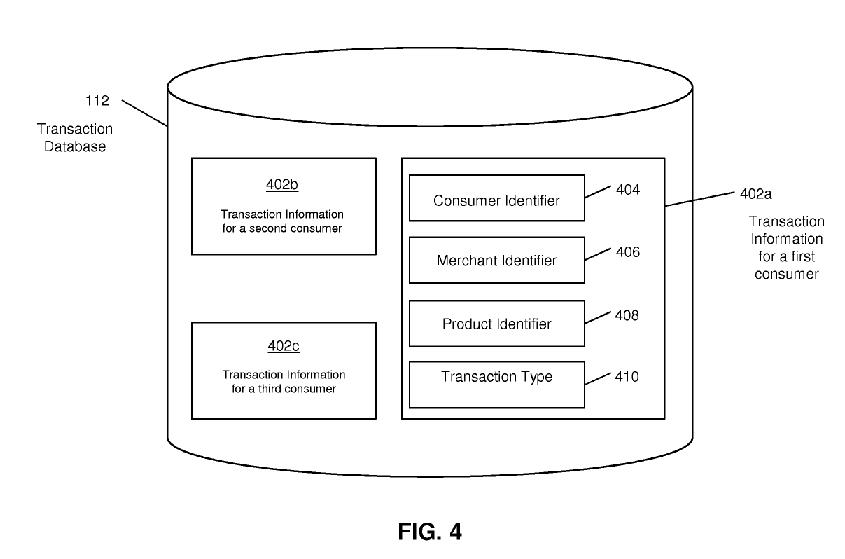

FIG. 4 illustrates an exemplary structure of the transaction database 112. The transaction database 112 may have plural entries 402a, 402b, 402c, etc. corresponding to each consumer and the associated transaction information. Each entry storing the transaction data for a given consumer 102 may include, but is not limited to, the customer identifier 404, merchant identifier 406, product identifier(s) 408, transaction type 410, time, date, amount, etc. It will be apparent to persons having skill in the relevant art that the embodiment of the transaction database 112 illustrated in FIG. 4 is provided as illustration only and may not be exhaustive to all possible configurations of the transaction database 112 suitable for performing the functions as discussed herein.

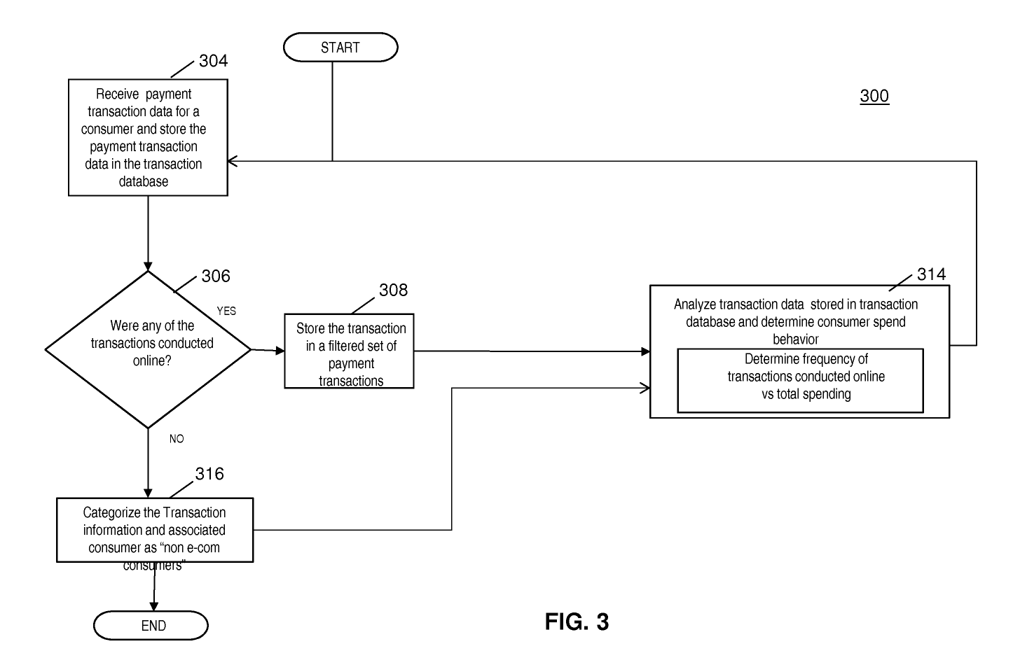

FIG. 3 illustrates a method 300 for analyzing consumer spending behaviors using the processing server 110.

At Step 304, the receiving device 202 receives the transaction data 124 for a plurality of transactions conducted by the consumer 102. The transaction data 124 may include a plurality of purchase attributes associated with each of the payment transactions conducted by the consumer 102. The purchase attributes may include, but are not limited to, product data, one or more product identifiers (e.g., phones), one or more product names (e.g., iPhone®), transaction time and location, merchant identifier (e.g., communication devices), merchant name (e.g., Apple®), industry identifier (e.g., electronics), industry category (e.g., high-end electronic devices), and/or a consumer identifier (e.g., information about the consumer 102). A person skilled in the art would appreciate that additional purchase attributes may be included in the transaction data 124 transmitted from the payment network 108 to the processing server 110.

At Step 306, the processing server 110 in the processing server analyses the received transaction data 124 to filter the payment transactions that were conducted online. If a consumer does not have any payment transactions that were conducted online, the processing server 110 categorizes the transaction information and the consumer as “non e-commerce consumer” at Step 316.

If at Step 306, the processing server 110 determines that any of the payment transactions were conducted online, the processing server 110 filters the payment transactions conducted online and stores the associated transaction data in the transaction database 112 and the consumer database 114 at Step 308. Next, at Step 314, the processing server 110 analyzes the payment transactions stored in the transaction database to determine the consumer spend behaviors. In one instance, the processing server 110 may determine the frequency of the payment transactions conducted online as a relationship to the consumer's total spending. Other examples of the analysis performed by the processing server 110 are discussed below in more detail. The method is repeated for a plurality of consumers.

The processing server 110 may further analyze the filtered set of payment transactions and the associated transaction data 124 stored in the transaction database 112 and the consumer database 114. For instance, the processing server 110 may categorize the filtered set of payment transactions based on one of the purchase attributes and generate an aggregated report. The aggregated report may be displayed on a display device. In one aspect of the system and method disclosed here, the processing server 110 may transmit the aggregated report to the advertising agency network 120.

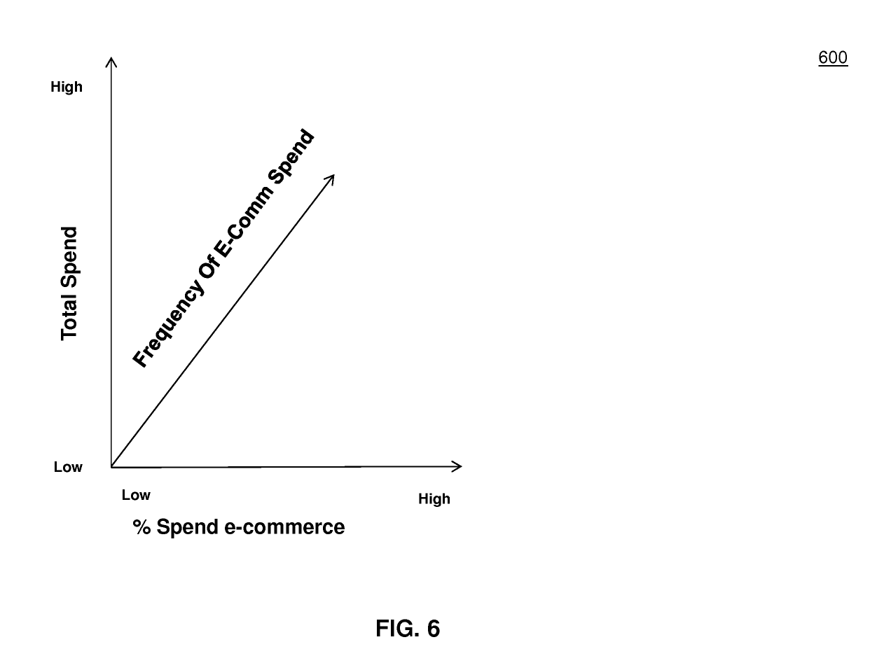

FIGS. 6-8 illustrate a non-exhaustive set of examples of the information that may be generated by the processing server 110 and presented in the aggregated report. The reports may be specific to an individual, whether identified or not, or aggregated to effectively make the individual consumers anonymous.

FIG. 6 shows a graph 600 illustrating the frequency of online spending (E-commerce spending) for a plurality of consumers. The horizontal axis represents the percentage of spending conducted online by a particular consumer. The percentage value on the horizontal axis may represent a percentage of online purchases made by a consumer using their transaction accounts. In another example, the percentage value on the horizontal axis may represent a percentage of online purchases made by a consumer using a particular transaction account. In still another example, the percentage value on the horizontal axis may represent a percentage of online purchases made by a consumer in a predetermined period of time.

The vertical axis represents the total amount of spending conducted by the consumer. The total spend amount on the vertical axis may represent the total money spent by a consumer using their transaction accounts. In another example, the total spend amount on the vertical axis may represent a total money spent by a consumer using a particular transaction account. In still another example, the total spend amount on the vertical axis may represent total money spent by a consumer in a predetermined period of time.

The graph 600 in FIG. 6 represents the frequency of money spent in online purchases. The plurality of consumers whose spend behavior is analyzed by the processing server 214 are charted on the graph. In the example shown in FIG. 6, a consumer whose substantial portion of spending occurs online (e.g., 75%) and spends a high amount during a given period of time (e.g., $10,000 over a period of six months) would be charted at the top-right corner of the graph and represent a frequent E-commerce spender. Similarly, a consumer who purchases online constitute a small portion of their total spending (e.g., 5%) and spends a low amount during a given period of time (e.g., $500 over a period of six months) would be charted at the bottom-left corner of the graph and represent an infrequent E-commerce spender. The above information would be particularly useful for offer providers, advertising agencies, and the like who can target their offers to consumers who qualify as being frequent E-commerce spenders.

As discussed above, the horizontal and vertical axes of the graph may be adjusted to categorize the consumers based on a plurality of purchase attributes. For instance, the processing server 214 may filter the consumers based on the product category (e.g., apparel). The vertical axis would represent the total amount of money spent by a consumer purchasing apparel. The horizontal axis would represent the percentage of the apparel purchases being made online by the consumer. The plurality of consumers may be further categorized based on the brand name of the apparel (e.g., Nike( ) or the merchant store (e.g., Amazon®, Macy®). The plurality of consumers may be further categorized based on the method of payment used for the online apparel transaction. For instance, consumers who use a particular transaction account to purchase a particular brand of apparel or from a particular merchant may be grouped together. The above information would be particularly useful for credit card companies, merchants, and the like who can target their offers (e.g., rebate offers or reward points for apparel purchases at the specific merchant stores) to consumers who qualify as being frequent E-commerce spenders in the sub-category.

In another exemplary embodiment, the processing server 214 may categorize consumers based on their grocery purchases. The vertical axis would represent the total amount of money spent by a consumer purchasing groceries. The horizontal axis would represent the percentage of the grocery purchases being made online by the consumer. The plurality of consumers may be further categorized based on the frequency of grocery purchase or the merchant store (e.g., Amazon®). The plurality of consumers may be further categorized based on the method of payment used for the grocery purchases. For instance, consumers who use a particular transaction account to purchase specific groceries (e.g., non-perishable items only) or from a particular merchant may be grouped together. The above information would be particularly useful for credit card companies, merchants, and the like who can target their offers (e.g., rebate offers or reward points for grocery purchases at the specific merchant stores) as well send timely offers (e.g., if the consumer purchases their groceries on a Monday, forwarding the offers on Sunday) to consumers who qualify as being frequent E-commerce spenders in the sub-category.

A person skilled in the art would appreciate that the above description is merely provided as examples, and that the consumers may be categorized based on a plurality of purchase attributes. For instance, the purchasing behavior of the consumers may be further monitored to determine the success rate of the offers being made by the advertising agency. For instance, consumers who purchase products using the offers may be grouped together and provided additional incentives.

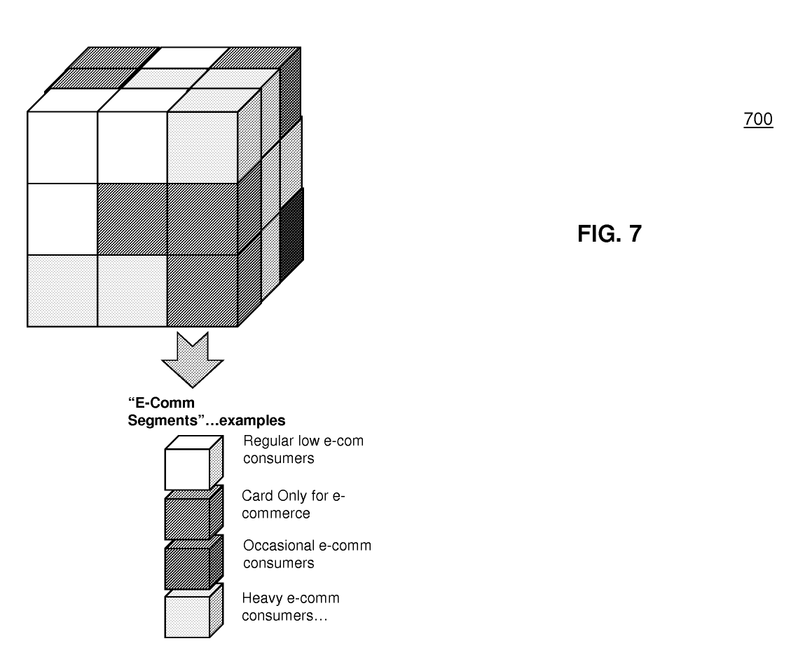

FIG. 7 shows a three-dimensional representation of the analysis results from the processing server 110 for a plurality of consumers.

The block 700 represents a plurality of consumers and may be segmented based on various spending attributes. In one example, the block 700 may represent the categorization of consumers based on their online grocery shopping. The block 700 has a plurality of faces which may define, in one exemplary embodiment, the type of groceries (e.g., non-perishable items on a first face, staple items such as milk/meat etc. on a second face, and frozen foods on a third face). Staple items would need to be shipped to the consumers more quickly than, for instance, non-perishable items. That is, the consumer's online spending behavior would be different based on the type of grocery, and the block 700 provides visual representation of the spending behavior of the consumers to the advertising agency in a more efficient manner.

For instance, the consumers may be segmented into groups including, but not limited to, regular low online grocery shoppers, occasional e-online grocery shoppers, and heavy online grocery shoppers. The consumers may further be segmented based on the method of payments used by the consumer. For instance, consumers who use a transaction account exclusively for online transactions may be grouped together separate from consumers who use the particular transaction account for both online and in-person transactions. Referring back to the grocery shopping example described above, a front face of the block 700 may represent the set of consumers shopping for frozen foods. The consumers may be segmented based on the total amount of money spent purchasing frozen foods within a predetermined period of time and the method of payment used. For instance, a consumer using a particular transaction account for only grocery shopping, and more particularly, for only purchasing frozen foods may be categorized separately from consumers whose online grocery shopping forms only a small portion of their total spending on the particular transaction account. In another exemplary embodiment, the consumers may be segmented based on the frequency of purchases made online.

The processing server 110 creates these segmentations based on the associated transaction data stored in the transaction database 112 and the consumer database 114. The processing server 110 analyzes the transaction data stored in the transaction database 112 to filter the transactions based on the desired purchase attribute (e.g., product category, merchant identifier, industry category, etc.). The processing server 110 then generates an aggregated report which may include, but is not limited to, visual presentations such as the graph 600 and/or the block 700. The aggregated report is then transmitted to the advertising agency network 120. The advertising agency network 120 may then use the aggregated report to generate offers targeted to consumers based on their online spending behavior. The above system allows for greater efficiency in targeting offers to the consumers and to deliver the products to the consumers based on their online spending behavior.

A person skilled in the art would appreciate that the three-dimensional block 700 may be customized to include any number of segments based on a plurality of purchase attributes and is not limited to the segments described above.

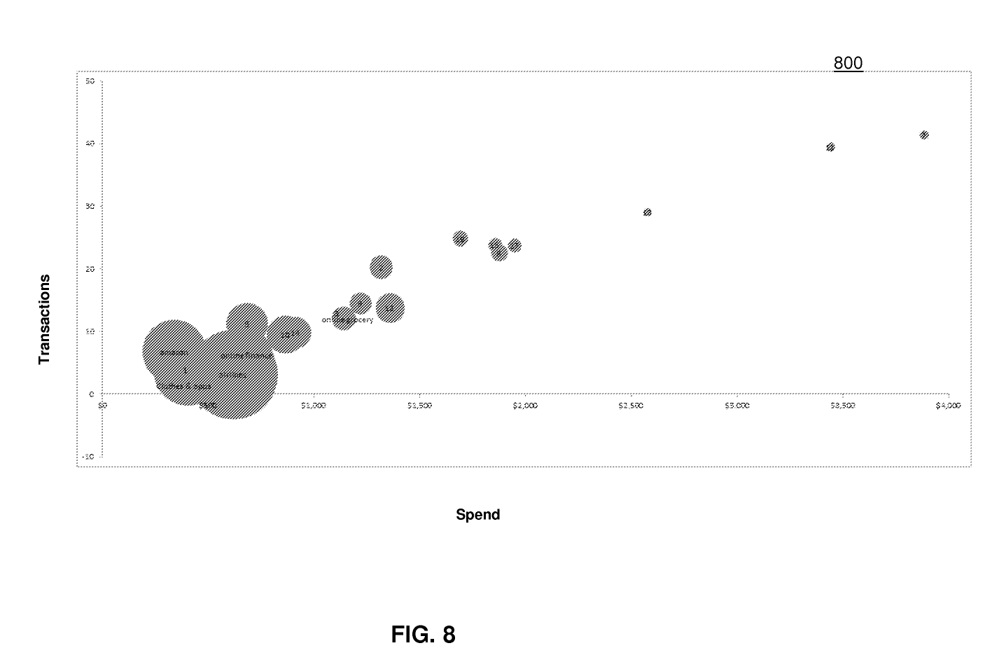

FIG. 8 illustrates a graphical representation 800 of breaking down each segment based on specific spend behaviors of the consumers into smaller clusters. The horizontal line in graph 800 indicates the amount spent on transactions conducted online for a particular purchase attribute (e.g., product category, merchant name, industry category, etc.) and the vertical line indicates the number of transactions made. The relative sizes of the various bubbles shown in graph 800 represent the number of consumers falling within a particular behavior cluster.

The following brief description of the bubbles is provided as only examples of the behavior clustering. The bubble labeled 1 at the bottom left of the graph 800 may represent the consumers shopping online. Within that bubble 1, the consumers may further be categorized based on the specific items purchased (e.g., clothes, appliances, airline tickets, etc.) or the merchant (e.g., Amazon®). That is, the graph 800 shows that a large number of consumers are likely to spend relatively small amounts of money on a relatively few transactions. Within that group of consumers, consumers who conduct online transactions at, for instance, Amazon® are represented at conducting a greater number of transactions with each transaction being of lower value per transaction. In contrast, consumers clustered in the bubble 1 purchasing airline tickets online, for instance, are represented as conducting fewer transactions with a larger amount of money spent on the transactions.

The additional behavior clusters may include, but are not limited to, segmenting online shoppers based on the type of purchases (e.g., groceries, apparel, shoes, entertainment, travel, etc.). These clusters may further be segmented into smaller groups. For instance, within the travel cluster, the consumers may be grouped together based on the mode of travel (e.g., airlines including specific airline preferences, trains, public transportation, etc.). The online shoppers may be clustered based on the merchant (e.g., Amazon®, Apple®). For instance, consumers clustered together in the bubble labeled 2 may represent consumers who shop at the Apple® Store (e.g., on applications or iTunes®). In the example shown in FIG. 8, these consumers conduct approximately twenty transactions over a predetermined period of time and spend approximately $1,500 over the period of time.

The consumers clustered based on merchants may further be segmented based on the type of transactions conducted with a specific merchant. For instance, consumers shopping at Amazon® for clothing may be grouped together separate from consumers shopping at Amazon® for electronics. In one aspect of the present disclosure, consumers who conducting online transactions for payments (e.g., utility bills, government fees, person to person payments, etc.) are grouped together. These consumers may be represented in, for instance, bubble labeled 5. In the example shown in FIG. 8, these consumers conduct approximately fifteen transactions over a predetermined period of time and spend approximately $750 over the period of time. FIG. 8 further shows that there are relatively more consumers conducting online transactions compared to Apple® Store consumers based on the relative sizes of the two bubbles. In another aspect, consumers who shop online for vouchers etc. (e.g., Groupon®) are placed in one segment.

In still another aspect, consumers may be segmented based on the type of product that a particular merchant is known for. By way of example, the processing server 110 may group together consumers who make purchases at Apple® and categorize the consumers as shopping from iTunes®, or categorize consumers conducting online transactions at PayPal® as consumers who send money online. A person skilled in the art would appreciate that any number of customizable segments may be generated by the processing serve 110 and is not limited to the examples discussed above.

Computer System Architecture

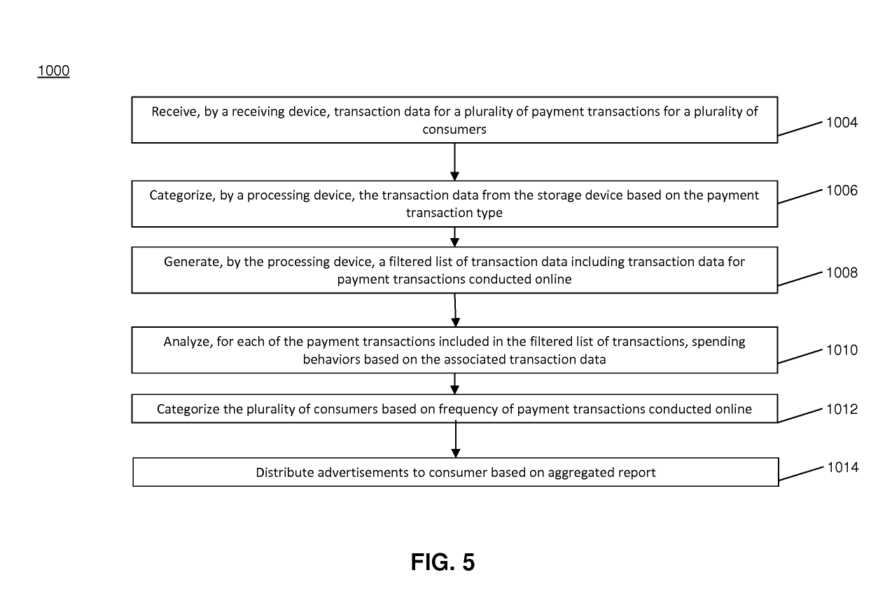

FIG. 9 illustrates a computer system 900 in which embodiments of the present disclosure, or portions thereof, may be implemented as computer-readable code. For example, the processing server 110 of FIG. 1 may be implemented in the computer system 900 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 918, a removable storage unit 922, and a hard disk installed in hard disk drive 912.

Various embodiments of the present disclosure are described in terms of this example computer system 900. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 904 may be a special purpose or a general purpose processor device. The processor device 904 may be connected to a communication infrastructure 906, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 908 (e.g., random access memory, read-only memory, etc.), and may also include a secondary memory 910. The secondary memory 910 may include the hard disk drive 912 and a removable storage drive 914, such as a floppy disk drive, a magnetic tape drive, an optical disk drive, a flash memory, etc.

The removable storage drive 914 may read from and/or write to the removable storage unit 718 in a well-known manner. The removable storage unit 918 may include a removable storage media that may be read by and written to by the removable storage drive 914. For example, if the removable storage drive 914 is a floppy disk drive, the removable storage unit 918 may be a floppy disk. In one embodiment, the removable storage unit 918 may be non-transitory computer readable recording media.

In some embodiments, the secondary memory 910 may include alternative means for allowing computer programs or other instructions to be loaded into the computer system 900, for example, the removable storage unit 922 and an interface 920. Examples of such means may include a program cartridge and cartridge interface (e.g., as found in video game systems), a removable memory chip (e.g., EEPROM, PROM, etc.) and associated socket, and other removable storage units 922 and interfaces 920 as will be apparent to persons having skill in the relevant art.

Data stored in the computer system 900 (e.g., in the main memory 908 and/or the secondary memory 910) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 900 may also include a communications interface 924. The communications interface 924 may be configured to allow software and data to be transferred between the computer system 900 and external devices. Exemplary communications interfaces 924 may include a modem, a network interface (e.g., an Ethernet card), a communications port, a PCMCIA slot and card, etc. Software and data transferred via the communications interface 924 may be in the form of signals, which may be electronic, electromagnetic, optical, or other signals as will be apparent to persons having skill in the relevant art. The signals may travel via a communications path 926, which may be configured to carry the signals and may be implemented using wire, cable, fiber optics, a phone line, a cellular phone link, a radio frequency link, etc.

Computer program medium and computer usable medium may refer to memories, such as the main memory 908 and secondary memory 910, which may be memory semiconductors (e.g. DRAMs, etc.). These computer program products may be means for providing software to the computer system 900. Computer programs (e.g., computer control logic) may be stored in the main memory 908 and/or the secondary memory 910. Computer programs may also be received via the communications interface 924. Such computer programs, when executed, may enable computer system 900 to implement the present methods as discussed herein. In particular, the computer programs, when executed, may enable processor device 904 to implement the methods illustrated by FIGS. 3 and 5, as discussed herein. Accordingly, such computer programs may represent controllers of the computer system 900. Where the present disclosure is implemented using software, the software may be stored in a computer program product and loaded into the computer system 900 using the removable storage drive 914, interface 920, and hard disk drive 912, or communications interface 924.

Techniques consistent with the present disclosure provide, among other features, systems and methods for analyzing spending data for online transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for analyzing spending data, comprising:
receiving, by a receiving device, transaction data for a plurality of payment transactions for a plurality of consumers, wherein the transaction data for each of the plurality of payment transactions includes at least purchase data and a payment transaction type;
categorizing, by a processing device, the transaction data from the storage device based on the payment transaction type;
generating, by the processing device, a filtered list of transaction data including transaction data for payment transactions conducted online; and
analyzing, for each of the payment transactions included in the filtered list of transactions, spending behaviors based on the associated transaction data,
wherein analyzing spending behaviors includes categorizing the plurality of consumers based on frequency of payment transactions conducted online.

2. The method of claim 1, wherein the purchase data includes as purchase attributes at least one of: product data, one or more product identifiers, one or more product names, a transaction time, a transaction date, a merchant identifier, a merchant name, a consumer identifier, an industry identifier, and an industry category.

3. The method of claim 2, further comprising:
associating, by the processing device, the filtered list of transaction data with at least one of the purchase attributes; and
displaying, by a display device, an aggregated report containing a list of transactions organized based on the purchase attribute.

4. The method of claim 2, further comprising:
associating, by the processing device, the filtered list of transaction data with at least one of the purchase attributes; and
displaying, by a display device, an aggregated report indicating frequency of transactions categorized based on the purchase attribute.

5. The method of claim 2, further comprising:
associating, by the processing device, the filtered list of transaction data with at least one of the purchase attributes; and
displaying, by a display device, an aggregated report indicating transaction amount categorized based on the purchase attribute.

6. The method of claim 1, further comprising:
determining a frequency of payment transactions conducted online within a predetermined period of time.

7. The method of claim 1, further comprising:
associating, by the processing device, the analyzed spend behavior for each of the payment transactions included in the filtered list of transactions to a consumer.

8. The method of claim 2, further comprising:
associating, by the processing device, the filtered list of transaction data with the merchant name;
associating, by the processing device, the merchant name with a primary product type; and
displaying, by a display device, an aggregated report categorizing the plurality of consumers based on the primary product type.

9. A system for analyzing spending data, comprising:
a receiving device configured to receive transaction data for a plurality of payment transactions for a plurality of consumers, wherein the transaction data for each of the plurality of payment transactions includes at least purchase data and a payment transaction type;
a processing device being configured to:
categorize the transaction data from the storage device based on the payment transaction type;
generate a filtered list of transaction data including transaction data for payment transactions conducted online; and
analyze, for each of the payment transactions included in the filtered list of transactions, spending behaviors based on the associated transaction data,
wherein analyzing spending behaviors includes categorizing the plurality of consumers based on frequency of payment transactions conducted online.

10. The system of claim 9, wherein the purchase data includes as purchase attributes at least one of: product data, one or more product identifiers, one or more product names, a transaction time, a transaction date, a merchant identifier, a merchant name, a consumer identifier, an industry identifier, and an industry category.

11. The system of claim 10, further comprising:
the processing device being configured to associate the filtered list of transaction data with at least one of the purchase attributes; and
a display device configured to display an aggregated report containing a list of transactions organized based on the purchase attribute.

12. The system of claim 10, further comprising:
the processing device being configured to associate the filtered list of transaction data with at least one of the purchase attributes; and
a display device configured to display an aggregated report indicating frequency of transactions categorized based on the purchase attribute.

13. The system of claim 10, further comprising:
the processing device being configured to associate the filtered list of transaction data with at least one of the purchase attributes; and
a display device configured to display an aggregated report indicating transaction amount categorized based on the purchase attribute.

14. The system of claim 9, wherein the processing device is further configured to determine a frequency of payment transactions conducted online within a predetermined period of time.

15. The system of claim 9, wherein the processing device is further configured to associate the analyzed spend behavior for each of the payment transactions included in the filtered list of transactions to a consumer.

16. The system of claim 10, further comprising:
the processing device being configured to associate the filtered list of transaction data with the merchant name;
the processing device being configured to associate the merchant name with a primary product type; and
a display device being configured to display an aggregated report categorizing the plurality of consumers based on the primary product type.

17. The system of claim 9, further comprising:
the processing device being configured to:
associate the filtered list of transaction data with a purchase attribute included in the purchase data;
generate an aggregated report containing a list of transactions organized based on the purchase attribute and the consumers associated with the transactions; and
transmit the aggregated report to advertising network;
the advertising network being configured to:
receive the aggregated report from the processing device;
generate an offer targeted at the consumers included in the aggregated report based on the associated transaction information included in the aggregated report;
transmit the offer to the consumers; and
deliver a product when the offer is used.
